(19) United States
(12) Patent Application Publication
(10) Pub. No.: US 2023/0321468 A1
(43) Pub. Date: Oct. 12, 2023

(54) FACE MASK

(71) Applicants: THE BRIGHAM AND WOMEN'S HOSPITAL, INC., Boston, MA (US); THE GENERAL HOSPITAL CORPORATION, Boston, MA (US); KATHAROS LABORATORIES, LLC, Boston, MA (US)

(72) Inventors: Jeffrey M. Karp, Boston, MA (US); Chulho Hyun, Boston, MA (US); Anthony Edward Samir, Boston, MA (US); Kisuk Yang, Boston, MA (US); Steven Gordon, Boston, MA (US)

(21) Appl. No.: 18/023,619

(22) PCT Filed: Sep. 2, 2021
(86) PCT No.: PCT/US2021/048839

§ 371 Date: Feb. 27, 2023

Related U.S. Application Data
(60) Provisional application No. 63/073,806, filed on Sep. 2, 2020.
(60) Provisional application No. 63/093,104, filed on Oct. 16, 2020.

(51) Int. Cl. A62B 23/02; A41D 13/11

(52) U.S. Cl. CPC A62B 23/025; A41D 13/1176

(57) ABSTRACT

Provided herein is a face mask that has a flexible filter body that is configured to fit over at least the mouth and the nose of a wearer. The face mask includes a shape-preserving strip extending along the periphery of the filter body. The shape-preserving strip is integral with the filter body and is configured to sufficiently seal the face mask against the wearer's face to minimize or prevent entry and/or exit of airborne particulate matter.

### CROSS-REFERENCE TO RELATED APPLICATIONS

This application claims priority to U.S. Provisional Application No. 63/093,104 filed on Oct. 16, 2020 and U.S. Provisional Application No. 63/073,806 filed on Sep. 2, 2020. Both applications are incorporated by reference in their entirety.

### TECHNICAL FIELD

The present disclosure relates to a face mask.

### BACKGROUND

Many current face mask designs for medical or industrial applications may have open gaps between the mask and the wearer's face in the cheek, nose/infraorbital and chin regions. Due to the presence of these open gaps, respired air can bypass the filter element, significantly reducing the efficacy of the face mask. Rectangular masks are particularly prone to gaps in these regions, as taut straps in the corners, which are typically used to hold the mask against the face, can create a compressive force along the side edges, bowing the mask material away from the face. These gaps are potential direct routes to a wearer's respiratory system for undesired bioaerosols, microdroplets, or particles.

Almost all commercially available face masks in the post-COVID-19 era contain a single malleable piece of material in proximity of their upper edge, which is made of a single-core bare metal wire, a plastic-coated wire or “twist tie,” a plastic strip, or an aluminum strip, etc. on the nose side either sandwiched between the filtering materials or on the external side of the face mask. However, such pieces are often either too short, too malleable or too springy to effectively form the mask upper edge along the contours of the nose. As a result, leakage on either side of a wearer's nose frequently occurs and contributes to fogging on a wearer's goggles or spectacles. Further, a short formable piece is frequently over-bent when pressed against soft skin. Thus, two ends of the over-bent piece are lifted leading to unexpected gaps in the infraorbital region. On the chin side of a wearer, a well-designed face mask extends under the chin forming a cup, which creates a conformal face seal. Mask leakage on the chin side may occur due to gaps formed because a wearer's jaw shape, conformability of the mask, and misaligned compressive force applied onto a wearer's face by, for example, elastic ear-loop straps.

Regarding comfort, available face masks have a formable nose piece that only provides a partial fit to a wearer's nasal and infraorbital regions with a compressive force onto the wearer's face exerted by elastic ear straps. Particularly, in tight-fitting facepiece filtering respirators such as an N95 mask, excessive force against a wearer's face is applied to maintain a good face seal. This constant force against the wearer's face over a long period of time can cause discomfort, skin irritation, and pain on the wearer's facial skin and/or the ears.

### SUMMARY

The present disclosure relates to face masks that are configured to minimize or eliminate gaps between the user's face and the face mask itself. In an aspect, a face mask is provided that comprises a flexible filter body configured to fit over at least the mouth and nose of a wearer. The flexible filter body has an interior surface configured to be positioned towards the face of the wearer, an exterior surface configured to be positioned away from the face of the wearer, and a periphery. The periphery includes a top portion configured to extend across the nose and infraorbital areas of the wearer, a left side portion and a right side portion configured to extend across the cheeks of the wearer, and a bottom portion configured to extend across or under the chin of the wearer. The face mask further includes a shape-preserving sealing strip extending along the top portion, the left side portion, the right side portion, and the bottom portion of the filter body. The shape-preserving sealing strip is integral with the filter body and is configured to sufficiently seal the face mask against the wearer's face to minimize or prevent entry and/or exit of airborne particulate matter. The face mask also includes a pair of ear straps and/or a head strap attached to the filter body that is configured to secure the face mask to the wearer's face.

In an aspect, a face mask is provided that comprises a flexible filter body configured to fit over at least the mouth and the nose of a wearer. The flexible filter body has an interior surface configured to be positioned towards the face of the wearer, an exterior surface configured to be positioned away from the face of the wearer, and a periphery. The periphery includes a top portion configured to extend across the nose and infraorbital areas of the wearer, a left side portion and a right side portion configured to extend across the cheeks of the wearer, and a bottom portion configured to extend across or under the chin of the wearer. A shape-preserving sealing strip extends along the top portion, the left side portion, and the right side portion. The shape-preserving sealing strip is integral with the filter body and is configured to sufficiently seal the face mask against the wearer's face to minimize or prevent entry and/or exit of airborne particulate matter. A cushion extends along the top portion, the left side portion and the right side portion of the filter body. The face mask also includes a pair of ear straps and/or or a head strap attached to the filter body that is configured to secure the face mask to the wearer's face.

### BRIEF DESCRIPTION OF THE DRAWINGS

FIG. 1A is a top view of the exterior surface of face mask according to an aspect of the present disclosure.

FIG. 1B is a top view of the interior surface of the face mask of FIG. 1.

FIG. 2A is a top view of the exterior surface of face mask according to an aspect of the present disclosure.

FIG. 2B is a top view of the interior surface of the face mask of FIG. 2A.

FIG. 3A is a top view of the exterior surface of a face mask according to an aspect of the present disclosure (ear straps and/or head strap not shown).

FIG. 3B is the face mask of FIG. 3A is a shaped configuration (ear straps shown).

FIG. 4 is an interior view of a shaped configuration (ear straps shown).

FIG. 5 is a cross-sectional view of a face mask (ear strap and/or head strap not shown) according to an aspect of the present disclosure.

FIGS. 6A-6C are photographs of a user wearing a prior art mask.

FIGS. 6D-6F are photographs of a user wearing a face mask according to an aspect of the present disclosure.

FIGS. 7A-7L are thermal IR images of a user wearing a prior art mask during inhalation in series.

FIGS. 8A-8L are thermal IR images of a user wearing a face mask according to an aspect of the present disclosure during inhalation in series.

FIG. 9A is a top view of the exterior surface of face mask according to an aspect of the present disclosure.

FIG. 9B is a top view of the interior surface of the face mask of FIG. 9A.

FIG. 10 is a top view of the interior surface of a face mask (ear straps and/or head strap not shown) is a shaped configuration according to an aspect of the present disclosure.

FIG. 11A is a top view of the exterior surface of a face mask according to an aspect of the present disclosure.

FIG. 11B is a top view of the interior surface of the face mask of FIG. 11A.

FIG. 12 is a top view of the interior surface of a face mask (ear straps and/or head strap not shown) is a shaped configuration according to an aspect of the present disclosure.

FIGS. 13A-13L are thermal IR images of a user wearing a face mask according to an aspect of the present disclosure during inhalation in series.

FIG. 14 is a chart indicating the mean temperature change in different mask surfaces during inhalation and exhalation.

FIG. 15A is a top view of the exterior surface of a face mask according to an aspect of the present disclosure.

FIG. 15B is a top view of the interior surface of the face mask of FIG. 15A.

FIG. 16A is a top view of the exterior surface of a face mask according to an aspect of the present disclosure.

FIG. 16B is a top view of the interior surface of the face mask of FIG. 16A.

FIGS. 17A-17L are thermal IR images of a user wearing a face mask according to an aspect of the present disclosure during inhalation in series.

FIGS. 18A-18G are photographs of a user wearing a face mask according to an aspect of the present disclosure during different stages of donning and doffing the face mask.

FIG. 19 is a perspective view of a face mask according to an aspect of the present disclosure.

FIGS. 20A and 20B are interior views of a face mask according to an aspect of the present disclosure.

### DETAILED DESCRIPTION

The present disclosure relates to face masks that are configured to minimize or eliminate gaps between the user's face and the face mask itself. The face mask can be disposable or non-disposable, can have a variety of geometric configurations, and can be fabricated from a variety of materials. The face masks minimize or prevent the transmission of bacterial and viral pathogens, for example, to protect against airborne particulate matter.

As used herein with respect to a described element, the terms “a,” “an,” and “the” include at least one or more of the described element(s) including combinations thereof unless otherwise indicated. Further, the terms “or” and “and” refer to “and/or” and combinations thereof unless otherwise indicated. By “substantially” is meant that the shape or configuration of the described element need not have the mathematically exact described shape or configuration of the described element but can have a shape or configuration that is recognizable by one skilled in the art as generally or approximately having the described shape or configuration of the described element. The terms “first,” “second,” etc. are used to distinguish one element from another and not used in a quantitative sense unless indicated otherwise. The terms “left,” “right,” “top” and “bottom” refer to the position of elements of the face mask when worn by a person and not as depicted in the figures unless otherwise indicated. In addition, when an element is referred to as being “on” “attached to,” “mounted on,” “disposed on,” “connected to,” “extending along,” or in “communication with” another element, it can be directly on, attach to, mounted on, disposed on, connected to, extending along, or in communication with the other element or intervening elements may also be present unless otherwise indicated. By “integral” or “integrated” is meant that the described components are fabricated as one piece or multiple pieces affixed during manufacturing or the described components are otherwise not separable using a normal amount of force without damaging the integrity (i.e. tearing) of either of the components such that the device no longer performs its intended function. A normal amount of force is the amount of force a user would use to remove a component meant to be separated from another component without damaging either component. As used herein a “wearer” or “user” includes a mammal such as a human being. As used herein, a “shape-preserving” element is an element that can be deformed and repeatedly reformed without breaking or tearing and can remain in shape once in its set position or has a permanent shape in a set position and remains in this permanent shape in the set position. The set position is when the mask covers, seals and forms around the wearer's face. As used herein a “shape-preserving sealing strip” is a strip that is configured to seal against or form on the wearer's face such that the amount of airborne particulate matter that enters into the mask or exits from the mask is minimized or reduced compared to a face mask that has no such shape-preserving sealing strip.

Although the drawings show certain elements of a face mask in combination, it should be noted that such elements can be included in other embodiments or aspects illustrated in other drawings or otherwise described in the specification. In other words, each of the disclosed aspects and embodiments of the present disclosure may be considered individually or in combination with other aspects and embodiments of the disclosure including patent applications incorporated by reference herein.

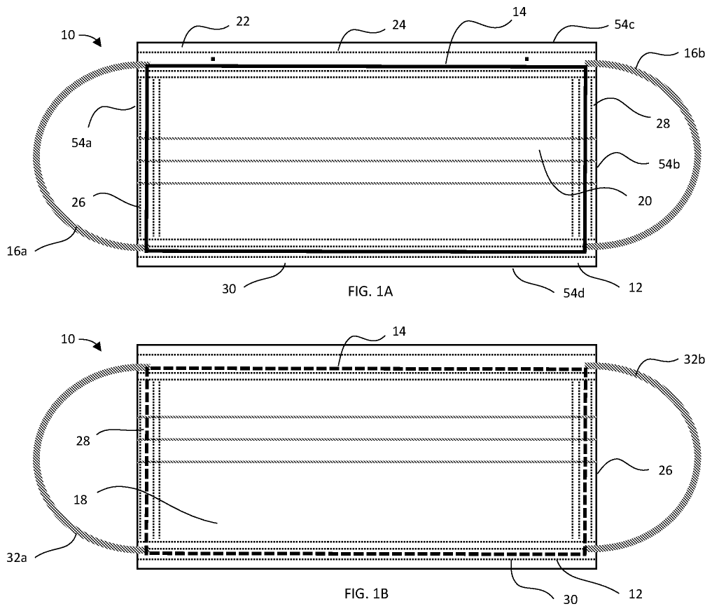

Referring to FIG. 1A-1B, in an aspect a face mask 10 is provided that comprises a flexible filter body 12, a shape-preserving sealing strip 14, and a pair of ear straps 16 and/or head strap. Filter body 12 is configured to fit over at least the mouth and nose of a wearer. Filter body 12 comprises an interior surface 18 configured to be positioned towards the face of the wearer and an exterior surface 20 configured to be positioned away from the face of the wearer. Filter body 12 also comprises a periphery 22 comprising a top portion 24 configured to extend across the nose and infraorbital areas of the wearer and a bottom portion 30 configured to extend across or under the chin of the wearer. Periphery 22 also includes a left side portion 26 and a right side portion 28 configured to extend across the cheeks of the wearer. In certain aspects, the left side portion and the right side portion are configured to extend vertically across the cheeks of the wearer. Regarding shape-preserving sealing strip 14, such a strip can extend along top portion 24, left side portion 26, right side portion 28 and bottom portion 30 of periphery 22 of filter body 12. The shape-preserving sealing strip is integral with the filter body and is configured to seal against or form on the wearer's face such that the amount of airborne particulate matter that enters into the mask or exits from the mask is minimized or reduced compared to a face mask that has no such shape-preserving sealing strip. Ear straps 16 or a head strap (not shown) are attached to filter body 12 and are configured to secure the face mask to the wearer's face.

Regarding the filter body, such a filter body can have a variety of shapes such as rectangular, asymmetrical, conical, etc. The filter body can fabricated from a woven or non-woven fabric and can be a mesh. Such shapes and materials are only exemplary. In general, the filter body can be similar to the filter body of a disposable 3-ply surgical mask, a sagitally foldable mask such as a KN95 style face mask, a N95 mask, a hyper purifying breathing (HPB) mask, Merrow mask, a 3-D style mask, or fabric mask, etc.

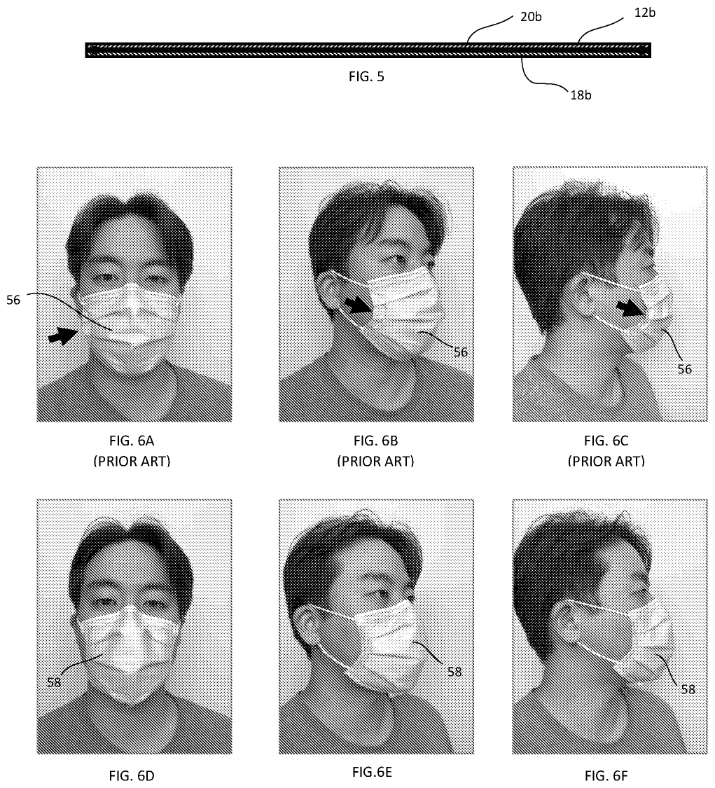

Regarding further details of the shape-preserving sealing strip 14, such a strip can be disposed on exterior surface 20 of filter body 12 as illustrated in FIG. 1A, disposed on interior surface 18A of filter body 12A as illustrated in FIG. 2B, or between interior surface 18B and exterior surface 20B of filter body 12B as illustrated in FIG. 5. Further the strip can extend along the entire periphery of the flexible filter body as illustrated in FIGS. 1 and 2 or can extend along the majority of the periphery of the filter body. In other words, the strip can be a continuous strip extending completely around the periphery of the filter body or there can be discontinuities or gaps in the strip so long as the strip serves the function of sealing or forming on the user's face such that the amount of airborne particulate matter that enters into the mask or exits from the mask is minimized or reduced compared to a face mask that has no such shape-preserving sealing strip. The shape-preserving sealing strip can be deformable and configured to be moldable by the wearer's hand to sufficiently seal the face mask against the wearer's face.

The shape-preserving sealing strip can be in the form of a wire, a wire mesh or a thin strip of material, for example. The shape-preserving sealing strip may include a single-core and/or multiple core wire with a circular or non-circular cross-sectional shape or a twist-tie-like structure with a paper and/or polymer jacket with an iron, steel or other ductile metal core. The shape-preserving sealing strip can be fabricated from various materials. For example, the strip can be fabricated from a metal, such as iron (e.g. zinc-galvanized iron wire); a metal alloy such as common steel, an aluminum alloy, or other shape-memory alloys; a non-metallic material such as a polymer material or silicone putty; a semi-metallic material; or suitable combinations thereof. Preferably, the shape-preserving sealing strip is fabricated from a non-foam material. The strip can have a range of sizes. For example, the strip can have a diameter of between 0.018 inches to 0.023 inches. For a disposable 3-ply mask having dimensions of approximately 175 millimeters (mm)×95 mm+/−5 mm, the segments of the strip that extends across the bottom portion of the filter body and the top portion of the filter body can each be about 140 millimeters (mm) to about 165 (mm). Preferably, the length of the strip at these portions are greater than 100 mm. The segments of the strip that extends across the left portion of the filter body and the right portion of the filter body can each be between about 75 mm to about 85 mm. Preferably, the length of the strip at these portions are greater than 75 mm. A length of the strip shorter than 90% of the mask cheek outmost edge 54a and 54b length was found to cause unexpected creases when worn in some use environments, creating undesired air-leaking gaps. Preferably, the distance between the outer most edge 54 of the periphery of filter body and the shape-preserving sealing strip is about 5 mm to about 10 mm and the strip covers greater than 35% of the face mask's total outer most peripheral edge 54. Such sizes and distances are exemplary and can depend on the shape, configuration and size of the filter body. The shape-preserving sealing strip can have different shapes depending on the shape of the filter body. For example, in certain aspects, the shape-preserving sealing strip can have a rectangular shape. The shape-preserving sealing strip can be manufactured and integrated into the filter body in a variety of ways. For example, four straight segments of the strip can be bonded by hot-melt glue or any soft glue such as silicone sealant and covered by a conformal adhesive-backed tape such as porous medical tape. Other methods of attaching and integrating the strip to the filter body include, for example, mechanical attachment by use of glue or silicone sealant, for example; ultrasonic welding; or taping with an adhesive-backed conformal material such as porous fabric or polymer sheet. Strips may also be bonded to the filter body by trapping them between the filter body and an additional layer of material, then bonding the additional layer by any of the aforementioned methods.

For the best performance and usability, it is important to choose a strip material that is easily bendable by the wearer, is sufficiently stiff to maintain its sculpted shape and sufficiently plastic to have a minimal (low) spring back as it is being formed. In a preferred embodiment, of the strip is constructed from 0.45 to 0.55 mm (0.018 to 0.022 inch) diameter annealed iron wire. This may be optionally coated with a plastic, paper, or combined plastic/paper material; however, the stiffness of the coating should be limited to reduce spring back. An overly stiff coating will not permit the strip to be easily and accurately formed to the shape of the wearer's face, as excessive spring back will produce gaps.

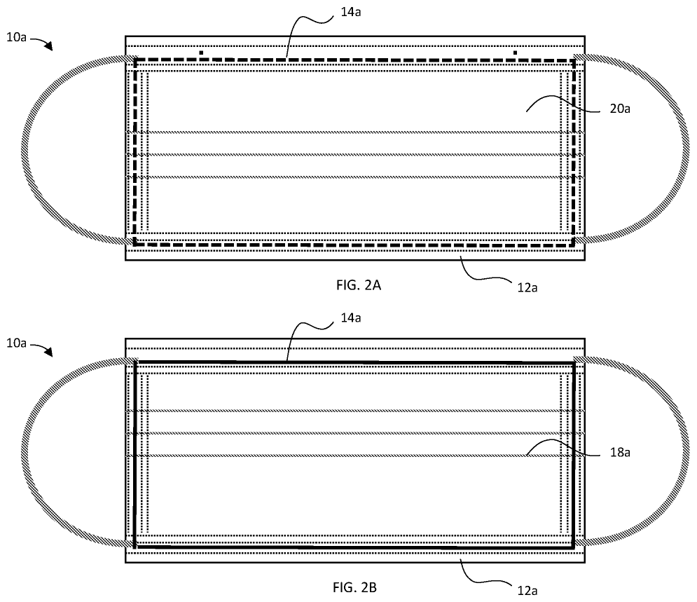

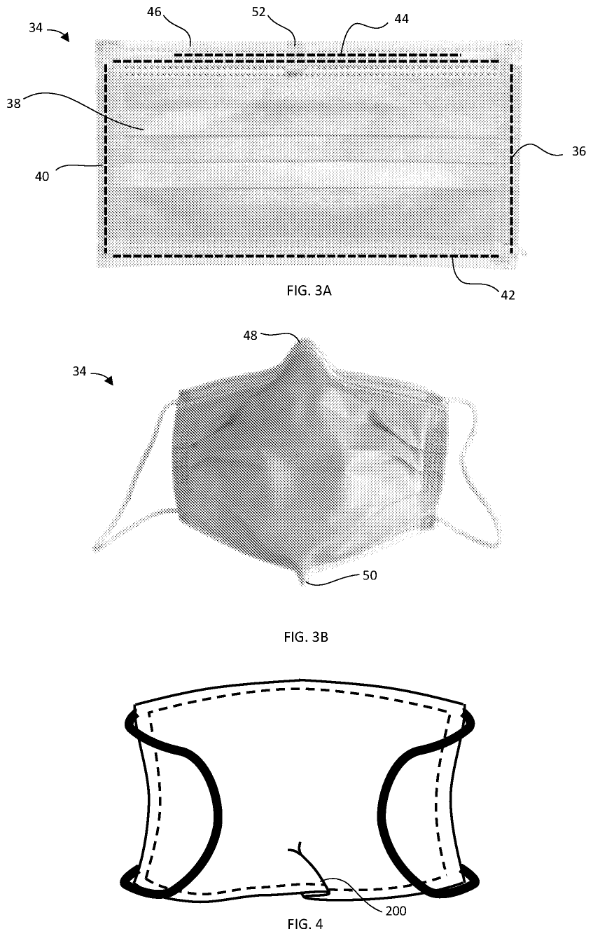

Referring to FIGS. 3A and 3B, a face mask 34 (ear straps and/or head strap not shown) can include a shape-preserving sealing strip 36 that is positioned between exterior surface 38 and interior surface 40 of filter body 42. Face mask 34 can also include a deformable nose bridge 44 extending partially or completely across top portion 46 (extending to right and left portions of the periphery) of filter body 42 and configured to be positioned across the nose of the wearer. The deformable nose bridge can also have shape-preserving sealing properties. Such a nose bridge can be fabricated from the same material as the shape-preserving sealing strip or can be fabricated from a different material. For example, the nose bridge can be a metallic wire. Such a nose bridge can be pinched to create a nose fold 48, as shown in FIG. 3B, to seal or form around the wearer's nose. In this aspect, such a seal around the wearer's nose is even more secure since there are two sealing elements: the nose bridge and the shape-preserving sealing strip that reinforces the nose bridge. The shape-preserving sealing strip and the nose bridge can overlie one another or can be adjacent to one another so long as the two elements are sufficiently close to create a seal around the wearer's nose when opposing surfaces of the shape-preserving strip and the nose bridge are pinched together. Face mask 34 can further include a graspable piece of material 52 attached to the section of top portion 46 configured to extend across the nose of the wearer. Such a graspable piece can be used by the wearer to pull the top portion of the mask over the wearer's nose. Specifically, the graspable piece can be a flap (referred to herein as a “nose flap”) on the external surface of the filter body and centrally located along the top portion of the filter body that acts as a handle to grab by the wearer's fingers to pull down the face mask for temporary doffing.

The shape-preserving sealing strip extending along bottom portion 42 of filter body 38 can be sufficiently malleable such that opposing surfaces of the strip can be pinched together to create a chin fold 50 similar to nose fold 48 to tighten the seal of the mask at or under the chin of the wearer. Such portion of the strip can also be sufficiently malleable and shape-preserving such that the chin fold be folded again to position the chin fold 200 under the wearer's chin in the transverse plane, as shown in FIG. 4. In an alternative embodiment, a separate chin strip can be incorporated into the face mask. Such a chin strip can also have shape-preserving sealing properties and can be reinforced by the shape-preserving sealing strip.

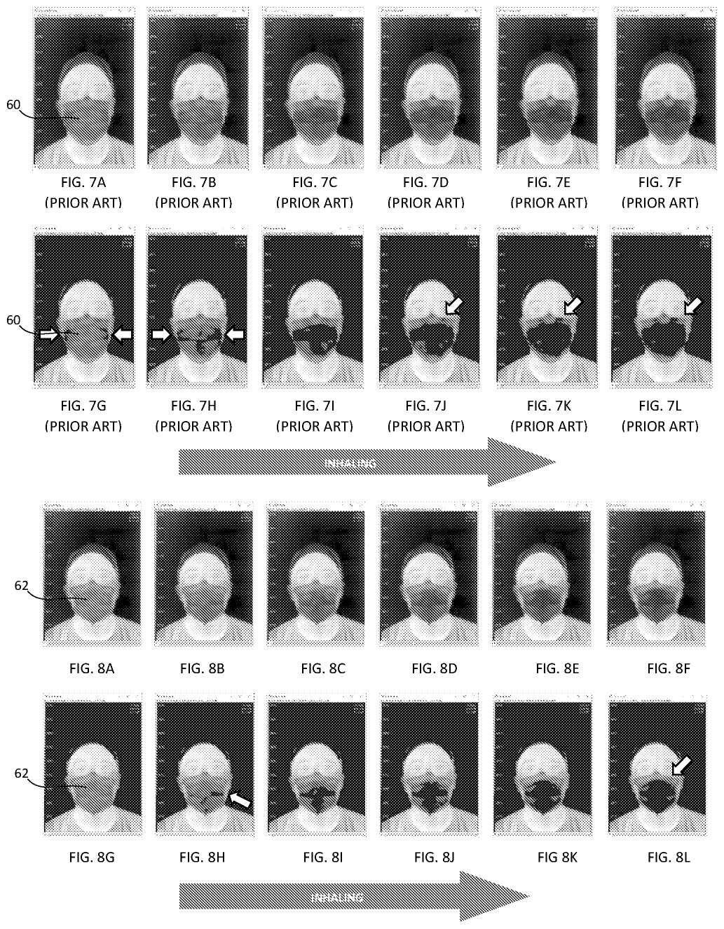

As stated above, the face masks have a shape-preserving sealing strip that seals or forms on the wearer's face such that the amount of airborne particulate matter that enters into the mask or exits from the mask is minimized or reduced compared to a face mask that has no such shape-preserving sealing strip. FIG. 6A-6C are photographs of a user wearing a disposable 3-ply face mask 56 without a shape-preserving sealing strip. As can be seen by the arrows, there are clear visible gaps between the user's face and face mask 56. FIGS. 6D-6F are photographs of a user wearing a face mask 58 that has a shape-preserving sealing strip. As can be seen from the arrows, there is no gap between the user's face and face mask 58. FIG. 7 depicts thermal IR images during sequential steps of inhalation (FIGS. 7A-7F) of a user wearing a disposable 3-ply face mask 60 without a shape-preserving sealing strip and FIGS. 7G-7L depict pixels below 29.5° C. overlaid with black coloring. The arrows show the areas where room air has leaked into mask 60. FIG. 8 depicts thermal IR images during sequential steps of inhalation (FIGS. 8A-8F) of a user wearing a disposable 3-ply face mask 62 that has a shape-preserving sealing strip. FIGS. 8G-8L depict pixels below 29.5° C. overlaid with black coloring. The arrows show significantly less or no leakage of room air into the mask 62 compared to mask 60.

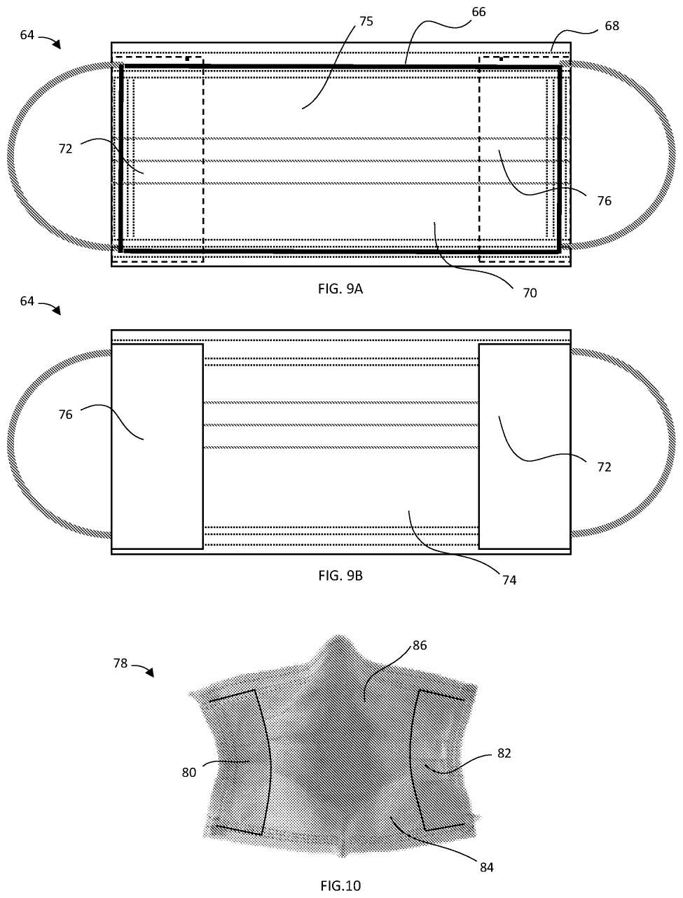

In certain aspects a face mask is provided that comprises a plurality of flaps with each flap having one end attached to the periphery of the interior surface of the filter body and another opposing free open end facing towards the center of the face mask. The flaps can be fabricated from the same material as the filter body or a different material. Exhaled air can enter the free open end and be trapped within the flap and the internal flaps can act as a droplet and aerosol barrier or containment when the mask cavity (space the mask and the wearer's face) undergoes a high pressure change such as when the user coughs or sneezes, for example. Referring to FIGS. 9A and 9B, in certain aspects a face mask 64 is provided that comprises a shape-preserving strip 66 disposed about the periphery 68 of filter body 70, a right flap 72 disposed on the right side portion of interior surface 74 of filter body 70, and left flap 76 disposed on the left side portion of the interior surface 74 of filter body 70. Although FIG. 9A illustrates strip 66 disposed on the exterior surface 75 of filter body 70, the strip can be disposed on the interior surface 74 or between the interior surface and the exterior surface as described above. FIG. 10 illustrates a face mask 78 in a donned configuration (ear straps and/or head strap not shown) with right and left flaps 80 and 82 respectively disposed on the interior surface 84 of filter body 86.

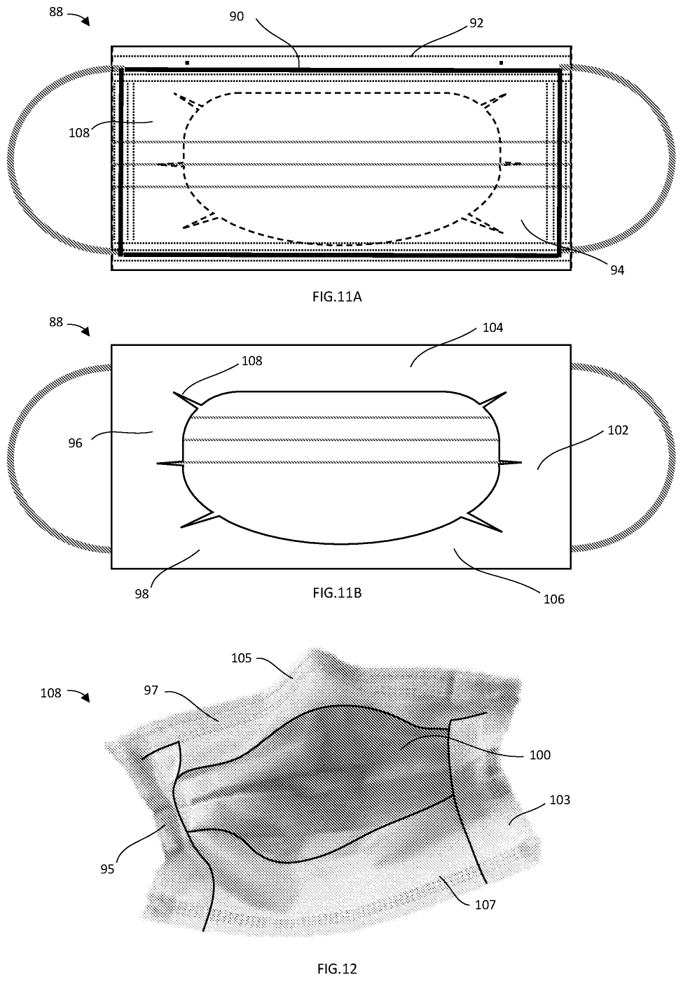

Referring to FIG. 11A-11B, in certain aspects a face mask 88 is provided that comprises a shape-preserving strip 90 disposed about the periphery 92 of filter body 94, a right flap 96 disposed on the right side portion of interior surface 98 of filter body 94, a left flap 102 disposed on the left side portion of interior surface 98 of filter body 94, a top flap 104 disposed on the top portion of interior surface 98 of filter body 94, and a bottom flap 106 disposed on the bottom portion of interior surface 98 of filter body 94. Although FIG. 11A illustrates strip 90 disposed on exterior surface 108 of filter body 94, the strip can be disposed on the interior surface 98 or between the interior surface and the exterior surface as described above. FIG. 12 illustrates a face mask 108 in a donned configuration (ear straps and/or head strap not shown) with flaps 95, 103, 105, and 107 disposed on interior surface 97 of filter body 100. Although FIGS. 11A-11B illustrate the flaps as a single integral continuous “window frame” piece, the flaps can be separate pieces as illustrated in FIG. 12. When the flaps are a single integral piece or even when they are separate pieces, the flaps can define cuts 108 to allow the mask to expand and not be overly constrained by a non-expandable “window frame.” In either aspect, the shape-preserving strip can be disposed directly on the interior surface of the filter body such that the strip is sandwiched between the interior surface of the filter body and the plurality of flaps.

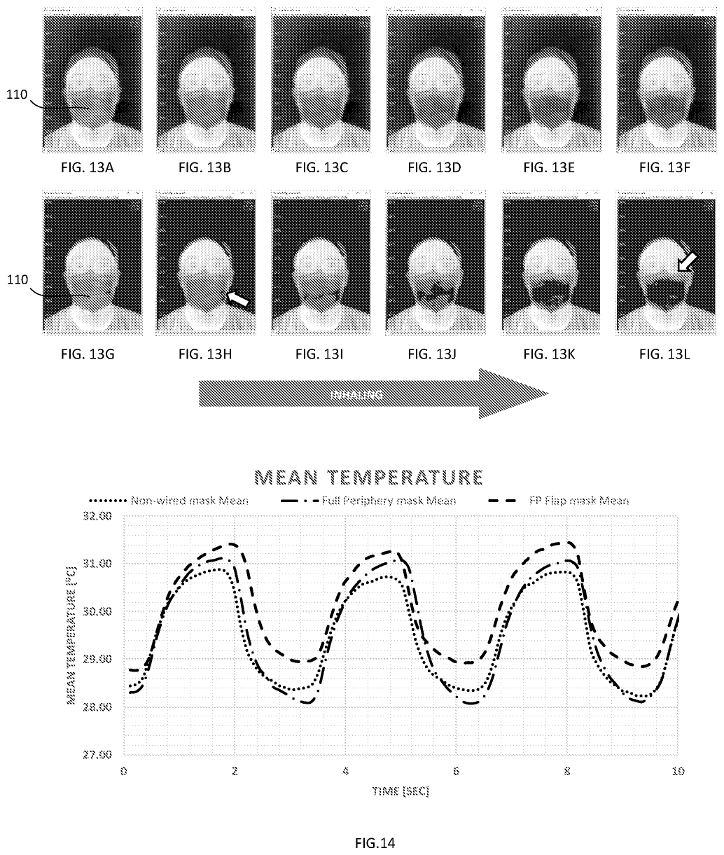

FIG. 13A-13L depicts thermal IR images during sequential steps of inhalation (FIGS. 13A-13F) of a user wearing a disposable 3-ply face mask 110 that has a shape-preserving sealing strip. FIGS. 13G-13L depict pixels below 29.5° C. overlaid with black coloring. The arrows show significantly less or no leakage of room air into the mask 110 compared to mask 60 (FIG. 7). Thus, the use of flaps in the face mask reduces gaps between the face mask and the wearer's face and leakage at the nose area and cheek area.

FIG. 14 is a graph that shows the mean temperature change of the mask surface of a traditional prior art face mask, a face mask with a shape-preserving sealing strip (referred to in this figure as a “full periphery mask”), and a face mask with internal flaps (referred to in this figure as a “flap mask”) during inhalation and exhalation. During inhalation, the mask surface temperature decreases due to low room temperature (approximately 29° C.) and during exhalation, the mask surface temperature increases due to warm breath. The results shown in FIG. 14 indicate that face masks with shape-preserving sealing strips that close any open gaps between the face mask and the user's face reach a high surface temperature due to minimized exhaled breath leakage. The mean value was calculated over a selection region, which was identical in all dimensions for all three face masks. The position of the selected region was adjusted to position the face mask between the eyes of the wearer and kept at a constant distance below the nose.

During exhalations, especially high flow coughs and sneezes, the shape-preserving sealing strips that close any open gaps between the face mask and the user's face will raise the air pressure on the inside of the mask body 100 beyond that of a conventional mask having larger gaps. Without the flap(s), this higher pressure would have the effect of pushing the mask body 100 away from the user's face; however, the flap(s) experience the higher pressure on the side opposite the face, thereby “inflating” the flap(s) and helping to seal the mask against the face. The inflated flaps push against the face making it more difficult for air to escape around the mask edges. Thus, the flaps and shape-preserving sealing strips act in concert with one another to better contain exhalations and direct airflow through the mask-body filtration system.

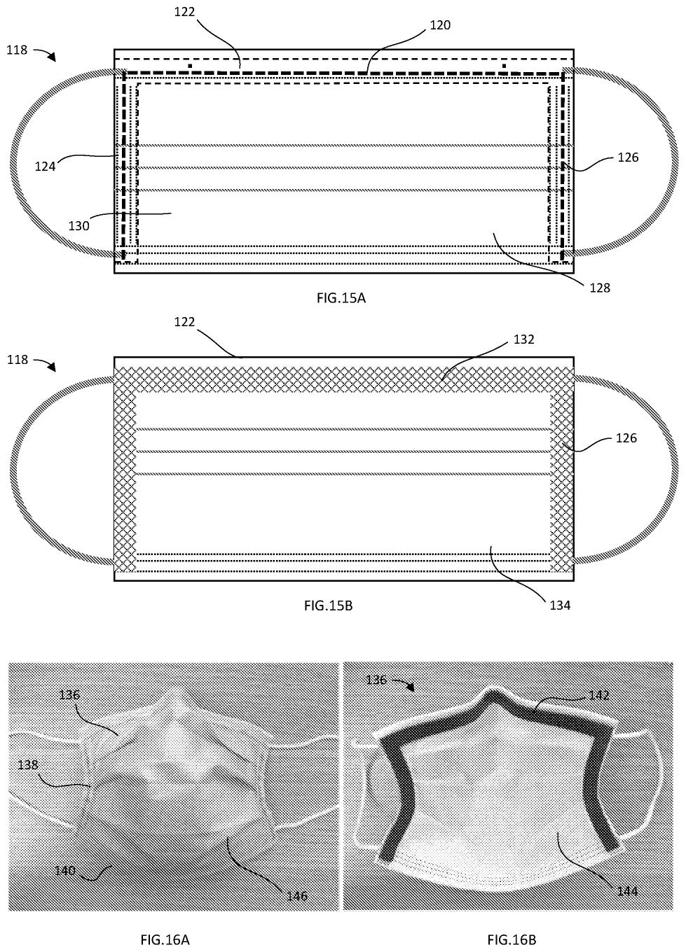

In certain aspects, a face mask includes a cushion disposed at least partially about the periphery of the interior surface of the filter body of the face mask to provide a comfortable leak-free face seal between the face mask and wearer's facial skin. Such a cushion can be disposed on the interior surface of the filter body. The shape-preserving sealing strip can be disposed on the exterior surface of the filter body, directly on the interior surface of the filter body such that the strip is sandwiched between the interior surface of the filter body and the cushion, or between the interior surface and the exterior surface. FIG. 15A illustrates a face mask 118 where shape-preserving sealing strip 120 extends at least along top portion 122, right portion 124, and left portion 126 of filter body 128. FIG. 15A illustrates strip 120 disposed on exterior surface 130 of filter body 128 but as stated above, the strip could be disposed directly on the interior surface or between the interior surface and the exterior surface of the filter body. Referring to FIG. 15B, cushion 132 extends along top portion 122, left side portion 126 and right side portion 124 of interior surface 134 of filter body 128. FIGS. 16A and 16B illustrate a face mask 136 where shape-preserving sealing strip 138 is disposed between the interior surface 144 and exterior surface 146 of filter body 140 and cushion 142 is disposed on interior surface 144 of filter body 140. The cushion can be fabricated from a variety of materials. For example, the cushion can be fabricated from low density polyvinyl chloride (PVC), neoprene, ethylene propylene diene monomer (EPDM), styrene-butadiene rubber (SBR), a foam sheet or foam tape

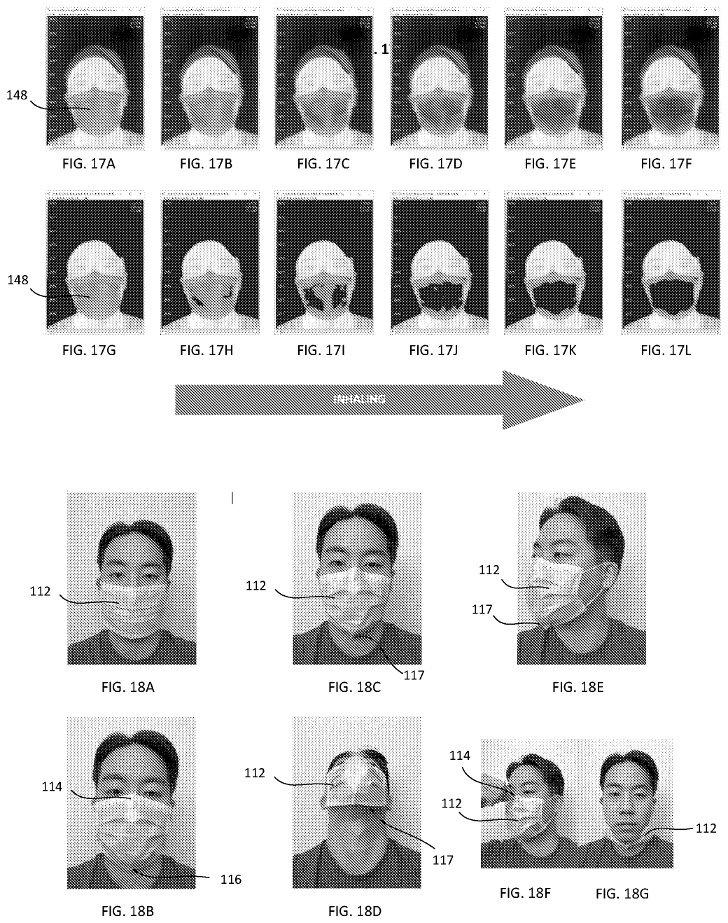

FIG. 17A-17L depicts thermal IR images during sequential steps of inhalation (FIGS. 17A-17F) of a user wearing a disposable 3-ply face mask 148 that has a shape-preserving sealing strip and cushion. FIGS. 17G-17L depict pixels below 29.5° C. overlaid with black coloring. The arrows show significantly less or no leakage of room air into the mask 148 compared to mask 60 (FIG. 7). Thus, the use of an additional cushion in the face mask reduces gaps between the face mask and the wearer's face and leakage at the nose area and cheek area.

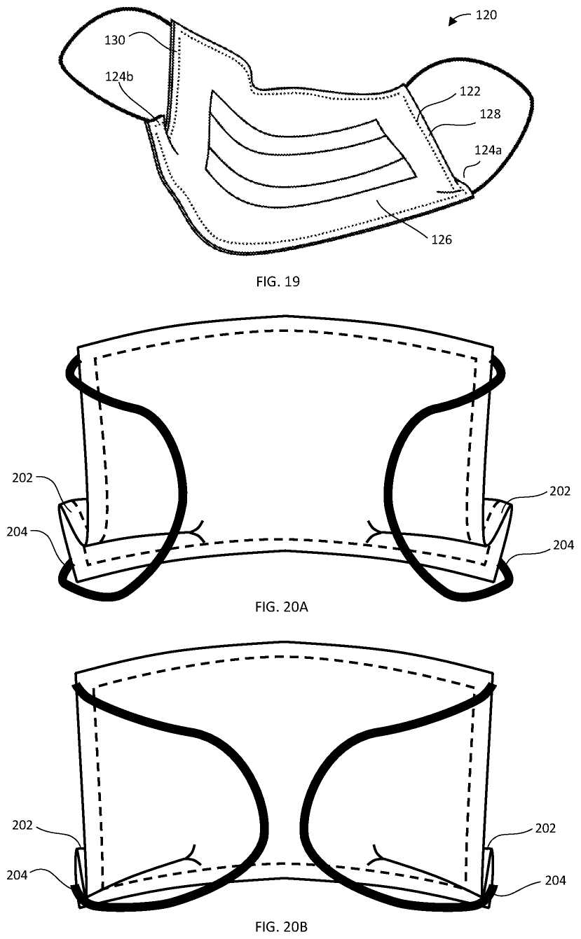

FIG. 19 depicts a face mask 120 where the shape-preserving sealing strip 122 has a Z shape on segments 124 of the strip extending along the bottom of the left and right portions 128 and 130 respectively of filter body 126. Such a Z shape has the effect of pulling in the lower strip edge under the jaw/chin, thereby creating a better seal at that region. Positioning the Z bend 202 proximate the elastic ear strap 204 attachment site helps a wearer pull the outer part of the Z shaped segment 202 against the face so that there is less leakage in the area of the Z-shaped segment. FIG. 20A shows the Z shape bends on segments 202 prior to tensioning the ear loops and FIG. 20B shows the Z shape segments 202 bends being compressed against the face subsequent to ear loop tensioning.

Also provided herein are methods of donning and doffing a face mask. Most traditional face masks have the following donning and doffing procedures. For donning, a wearer places a face mask on the face, pulls the straps around the ears or over the head, fits the upper portion over the nose and pulls the lower portion under the chin. The wearer may mold the mask around the nose by pressing a formable nose piece around the nose contours using his or her fingers. For doffing procedure, the wearer may unhook or untie the straps from the ears or head and then remove the face mask.

For donning a face mask having a shape-preserving sealing strip, the wearer places the face mask on as described above. However, the wearer may also mold the shape-preserving sealing strip using his/her fingers starting in the nose region, the infraorbital region, the zygomatic region, the buccal region and the mental region. In the chin region, the wearer may pinch the shape-preserving sealing strip to create a “chin fold” and then fold this chin fold under the chin, which tightens the seal along the entire periphery of the face mask. For doffing, the wearer may remove the mask as described above.

FIG. 18A-18G are photographs that illustrate an exemplary method of donning and doffing a face mask with a shape-preserving sealing strip as described herein. As seen in FIG. 18A, the face mask 112 can be placed on the face by looping ear straps around the wearer's ear. The wearer can grab the nose flap 114 and the bottom portion 116 of face mask 112 and pull up the face mask over the nose and pull down the bottom portion of the face mask under the chin such that the pleats of the face mask are expanded fully as seen in FIG. 18B. As can be send from FIG. 18B, the shape-preserving sealing strip does not interfere with the ability to expand/unfold the pleats of the face mask. The wearer can use his or her fingers (such as the middle finger and the index finger, for example) of both hands to sculpt the periphery of the face mask against the wearer's face as shown in FIG. 18C, starting from the nose and moving towards the cheeks, for example. The wearer can then pinch the shape-preserving sealing strip at the bottom portion 116 of the face mask to create a chin fold 117 as seen in FIG. 18C and can secure the chin fold by folding the chin fold to under the chin. The wearer can sculpt all four sides of the face mask (extending along the nose, chin, and cheeks) to close any gaps between the wearer's face and the face mask such that the face mask is sealed and formed to the wearer's face as seen in FIG. 18D. This includes pinching the shape-preserving strip extending along the left and the right side portions of the filter body to tighten the seal of the face mask at the cheeks and/or under the chin of the wearer. To doff the face mask, the wearer can grab nose flap 114 and pull down the face mask as seen in FIGS. 18F and 18G.

### Examples

Several types of face masks were analyzed with thermal IR imaging and traditional Schlieren imaging to identify leakage points while a wearer is normally breathing through the nose. Image processing techniques such as image registration, thresholding, contrast adjustment, were utilized to identify surface temperature changes from thermal IR videos. Thermal IR imaging was the primary imaging method to iterate and improve face mask designs.

### Test Setup

A SEEK Thermal CompactPRO was connected to an iPhoneX, which was held on a tripod the same height as a seated subject's face. The SEEK Thermal's app was used to set the IR camera with full-field mode with grayscale and jet colormaps. Recorded video was saved in the iPhoneX and transferred to a PC for image processing with ImageJ v1.52p and MATLAB 2020a. In prior experiments, FLIR T440 camera was used instead of a SEEK Thermal CompactPRO.

Preliminary tests showed that when a wearer inhales at relatively low, constant room temperature, such as 25° C., the surface temperature of the worn mask decreases as relatively cool air passes through the mask. When the wearer exhales, the surface temperature increases as relatively warm breath leaves through the mask. (See FIG. 14). The visually indistinguishable gap between the mask and the wearer's face can be visualized with thermal IR imaging as leaking air affects the temperature of a nearby object. The benefits of using thermal IR imaging as a tool for leakage detection and analysis are: 1) a non-destructive method—a pressure leakage test using equipment such as PortaCount for quantitative fit test requires punching a hole on the mask's filtering media for installing a port and 2) visualization of air circulation inside the mask—air circulation inside a mask is affected by several factors such as location of leakage points and the shape of expanded pleats. Using a simple image processing technique, heat difference map, a temperature gradient of the mask's surface can be visualized and provides insights for the configuration of the face mask. The heat difference map produces visualization like Schlieren imaging showing in which direction air is moving.

If there is leakage between a mask and a wearer, inhaled and exhaled air bypasses filtering media because filtering media is resistant to free air flow by at maximum 343 Pa. Since some of the respirated air flows through leakage points, which are typically found on the non-filtering edges of a face mask, activated filtering region on the mask is smaller during both inhaling and exhaling periods, which can be visualized effectively with thermal IR imaging when surrounding air temperature is lower than the exhaled breath temperature. Therefore, observed minimum, maximum and mean surface temperature of a filtering media would be less than those without leakage.

From the thermal IR test results, it was found that the temperature-varying region on the mask is not a consistent metric for quantifying leakage because the mask's total surface area is not the same. However, in some cases, it provides insights of thermal characteristics of a face mask. Minimum, maximum and mean temperature of a selected region is a useful metric and has consistent results. Also, a more direct indication of detecting visually indistinguishable gaps is a temperature change on the rim of a mask and the size of the area undergoing temperature change.

Each of the disclosed aspects and embodiments of the present disclosure may be considered individually or in combination with other aspects and embodiments. Further, while certain features of embodiments may be shown in only certain figures, such features can be incorporated into or deleted from other embodiments shown in other figures or otherwise disclosed in the specification. Additionally, when describing a range, all points within that range are included in this disclosure.

What is claimed is:

1. A face mask comprising:
a flexible filter body configured to fit over at least the mouth and nose of a wearer, the flexible filter body having:
an interior surface configured to be positioned towards the face of the wearer;
an exterior surface configured to be positioned away from the face of the wearer;
a periphery comprising:
a top portion configured to extend across the nose and infraorbital areas of the wearer;
a left side portion and a right side portion configured to extend across the cheeks of the wearer; and
a bottom portion configured to extend across or under the chin of the wearer;
a shape-preserving sealing strip extending along the top portion, the left side portion, the right side portion, and the bottom portion of the filter body, the shape-preserving sealing strip integral with the filter body and configured to sufficiently seal the face mask against the wearer's face to minimize or prevent entry and/or exit of airborne particulate matter; and
an ear strap and/or a head strap attached to the filter body configured to secure the face mask to the wearer's face.

2. The face mask of claim 1, wherein the shape-preserving sealing strip is deformable and configured to be moldable by the wearer's hand to sufficiently seal the face mask against the wearer's face.

3. The face mask of claim 2, wherein the moldablility is a combination of easily bendable by the wearer, sufficiently stiff to maintain its shape and sufficiently plastic to have a low spring back as it is being formed.

4. The face mask of claim 3, wherein the shape-preserving sealing strip is constructed from iron wire with a diameter between 0.45 and 0.55 mm.

5. The face mask of claim 1, wherein the left side portion and the right side portion are configured to extend vertically across the cheeks of the wearer.

6. The face mask of claim 1, wherein the shape-preserving sealing strip is fabricated from a non-foam material.

7. The face mask of claim 1, wherein the shape-preserving sealing strip is disposed on the interior surface of filter body.

8. The face mask of claim 1, wherein the shape-preserving sealing strip is disposed on the exterior surface of the filter body.

9. The face mask of claim 1, wherein the shape-preserving sealing strip is disposed between the exterior surface and the interior surface of the filter body.

10. The face mask of claim 1, wherein the shape-preserving sealing strip extends along the entire periphery of the flexible filter body.

11. The face mask of claim 1, wherein the shape-preserving sealing strip extends along the majority of the periphery of the flexible filter body.

12. The face mask of claim 1, further comprising a plurality of flaps, each flap having one end attached to the periphery of the interior surface of the filter body and another opposing free open end facing towards the center of the filter body.

13. The face mask of claim 12, the plurality of flaps comprising:
a right flap disposed on the right side portion of the interior surface of the filter body, the right flap having one end attached to the periphery of the face mask on the right side portion and having an opposing free end facing towards the center of the face mask; and
a left flap disposed on the left side portion of the interior surface of the filter body, the left flap having one end attached to the periphery of the face mask on the left side portion and having an opposing free end facing towards the center of the face mask.

14. The face mask of claim 13, the plurality of flaps further comprising:
a top flap disposed on the top portion of the interior surface of the filter body, the top flap having one end attached to the periphery of the face mask on the top portion and having an opposing free end facing towards the center of the face mask; and
a bottom flap disposed on the bottom portion of the interior surface of the filter body, the bottom flap having one end attached to the periphery of the face mask on the bottom portion and having an opposing free end facing towards the center of the face mask.

15. The face mask of claim 12, wherein the shape-preserving sealing strip is disposed directly on the interior surface of the filter body such that the shape-preserving sealing strip is sandwiched between the interior surface and the plurality of flaps.

16. The face mask of claim 7, further comprising:
a cushion disposed on the shape-preserving sealing strip such that the shape-preserving sealing strip is sandwiched between the interior surface of the filter body and the cushion.

17. The face mask of claim 16, wherein the cushion is disposed on the shape-preserving sealing strip at the top portion, the right portion, and the left portion of the filter body.

18. The face mask of claim 1, further comprising a deformable nose bridge extending at least partially across the top portion of the filter body and configured to be positioned across the nose of the wearer.

19. The face mask of claim 1, wherein the shape-preserving sealing strip extending along the bottom portion of the face mask is sufficiently malleable such that opposing surfaces of the strip can be pinched together to tighten the seal of the face mask at or under the chin of the wearer.

20. The face mask of claim 19, wherein the bottom flap attachment is sufficiently sealed to the mask filter body to trap a portion of exiting airflow from escaping through the pinched portion of the mask.

21-29. (canceled)
